(19) United States
(12) Patent Application Publication
(10) Pub. No.: US 2024/0210194 A1
(43) Pub. Date: Jun. 27, 2024

(54) DETERMINING PLACES AND ROUTES THROUGH NATURAL CONVERSATION

(71) Applicant: GOOGLE LLC, Mountain View, CA (US)

(72) Inventor: Matthew Sharifi, Mountain View, CA (US)

(21) Appl. No.: 17/919,962

(22) PCT Filed: May 2, 2022
(86) PCT No.: PCT/US22/27279

§ 371 Date: Oct. 19, 2022

(51) Int. Cl. G01C 21/36; G10L 15/22

(52) U.S. Cl. CPC G01C 21/3608; G10L 15/22; G10L 2015/223; G10L 2015/225

(57) ABSTRACT

A computing device may implement a method for determining places and routes through natural conversation. The method may include receiving, from a user, a speech input including a search query to initiate a navigation session; and generating a set of navigation search results responsive to the search query. The set of navigation search results include a plurality of destinations or a plurality of routes corresponding to one or more destinations. The method further includes providing an audio request to the user for refining the set of navigation search results, and in response to the audio request, receiving, from the user, a subsequent speech input including a refined search query. The method further includes providing one or more refined navigation search results responsive to the refined search query including a subset of the plurality of destinations or the plurality of routes.

### FIELD OF THE DISCLOSURE

The present disclosure generally relates to route determinations and, more particularly, to determining places and routes through natural conversation.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, conventional navigation applications that provide directions to/from destinations are ubiquitous in modern culture. These conventional navigation applications may provide directions and turn-by-turn navigation in order to reach a pre-programmed destination by driving and/or several other modes of transportation (e.g., walking, public transportation, etc.). In particular, conventional navigation applications allow users to specify source and destination points, after which the users are presented with a set of route proposals based on different modes of transportation. Thus, these route proposals are typically provided to the user as the result of a single interaction between the user and the application, wherein the user enters a query and is subsequently presented with a list of route proposals.

However, in situations where there are a wide range of available routes or the user is flexible in terms of the exact destination, this conventional single interaction methodology may be inadequate. For example, a user may desire to navigate to a hiking trail without having a particular hiking trail in mind, and as a result, there may be a very large number of possible route configurations to reach multiple different hiking trails. If each of these route options is displayed, they may likely overwhelm the user or simply take too long to browse through, such that the user may select an undesirable route or no route at all. Moreover, displaying each of the large number of routes requires a correspondingly large amount of computational resources in order to determine and provide each of those routes at the client device.

Thus, in general, conventional navigation applications fail to provide users with route proposals that are accessible and specifically tailored to the user, and a need exists for a navigation application that can determine places and routes through natural conversation to avoid these issues associated with conventional navigation applications.

### SUMMARY

Using the techniques of this disclosure, a user's computing device may enable the user to select a destination and a route through a back and forth conversation with a navigation application. In particular, the user may initiate a directions query (e.g., a navigation session) through a spoken or typed natural language request, which may lead into follow-up questions from the navigation application and/or further refinements from the user. The navigation application utilizing the present invention may then refine the routes/destinations provided to the user based on the user's responses to the follow-up questions. In this manner, the present invention enables users to refine their destination or route selection in a more natural way than conventional techniques through a two-way dialogue with their device. As a result, the present invention may reduce time and cognitive overhead on the user because it removes the need to browse through a long list of different route proposals and try to manually compare them. In this way, the present invention solves the technical problem of efficiently determining a route to a destination. This is further enabled by the fact that the routes provided to the user for selection are a refined list of all possible routes, meaning that the computational requirements required to provide the routes to the user is reduced compared to conventional techniques, since there are less routes to provide. In this way, the present invention provides a more computationally efficient means for determining routes to a destination. An additional technical advantage provided by the present invention is that of a safer means for providing routes to a user for selection. The disclosed techniques in which a user is able to refine a set of routes to a destination and select a route via a speech input are less distracting to the user compared to conventional techniques of viewing route displayed on a screen and selecting one of those routes via touch input. The disclosed techniques enable an operator of a vehicle to select a route without taking their eyes off of the road, and without taking their hands off of the vehicle controls. Moreover, a user who is an operator of a vehicle is able to safely refine or update the route whilst they are already travelling along that route using speech input and a conversational interface. In this way, the disclosed techniques provide a safer means for selecting and refining a route to a destination. Further, the present invention can also provide route suggestions which better meet the needs and preferences of the user than conventional techniques because the user is encouraged to explicitly state their preferences as part of the conversational flow. However, embodiments of the present invention are not specifically limited to achieving effects based on user preferences. Some disclosures of the present invention are agnostic of user preferences.

The present invention may work in the setting of either a speech-based or a touch-based interface. However, for ease of discussion, the conversation flow between the user and the navigation application (and corresponding processing components) described herein may generally be in the context of a speech based configuration. Nevertheless, in the case of a touch-based interface, clarification questions can be displayed to a user in the user interface and the clarification questions may be answered via free-form textual input or through UI elements (e.g. a drop-down menu). Embodiments disclosed herein that are described in the context of a speech-based interface may also be applied to the context of a touch-based interface. All embodiments disclosed herein in which inputs or outputs are described in the context of a speech-based interface may be adapted to apply to the context of a touch-based interface.

In a first example, the techniques of the present disclosure may resolve a place when a user is flexible in terms of destination. A user may be traveling in Switzerland and may initiate a navigation session by speaking “navigate to a nearby hiking spot.” Given that there are a large number of hiking spots which satisfy the constraint of being “nearby,” the navigation system may respond to the user with an audio request: “What's the maximum amount of time you're willing to travel?.” in order to narrow down the set of routes. The user may respond to the audio request by stating “No more than 30 minutes by car.” However, as there are still a relatively large number of options available, the navigation application may generate a subsequent audio request, such as: “Some of the top rated options require taking a cable car from the parking lot, would you be willing to do that? The total journey time would likely be under 30 minutes.” The user may respond with “Yes, that's fine,” and the navigation application may respond with several options that are highly rated for hiking within 30 minutes of travel time, but include both driving and a cable car. The user may then further refine the returned route options with follow-up statements, or accept one of the provided suggestions.

In a second example, the techniques of the present disclosure may be configured to generate natural language route suggestions with refinements. A user may arrive at an airport in Italy and may want to navigate to their hotel. The user may ask their navigation application “Give me directions to Tenuta il Cigno.” The navigation application may respond with a few different route proposals along with a top candidate by stating: “The route I'd recommend is the shortest one but it involves driving 10 miles on a single track road.” Rather than accepting the proposal, the user may adjust the proposed route by saying “I'd definitely appreciate a short journey but is it possible to spend less time on the single track road?” The navigation application may then propose an alternate route which is longer but only involves 2 miles of driving on the single track road to reach the user's destination. The user may accept this alternate route, and may view the directions or begin the navigation session.

In a third example, the techniques of the present disclosure may provide conversational clarification during a navigation session. Similar to the above example, a user may be navigating to their hotel from the airport in a holiday destination. While the user is en route, the user encounters a potential detour along the way which would take a similar amount of time but has different properties. When approaching this detour, the navigation system may prompt the user by stating “There's an alternate route on the left with a similar ETA, it's a shorter distance but has some temporary road works which could cause a bit of a delay.” In response, the user may say “Ok let's take it,” or “No, I think I'll stick to the current route,” and the navigation application may continue with the original route or switch to the alternate route, as appropriate.

In this manner, aspects of the present disclosure provide a technical solution to the problem of non-optimal route suggestions by automatically filtering route options based on a conversation between the user and the navigation application. Aspects of the present disclosure also provide a technical effect to the problem of safer router refinement based on a conversational interaction between the user and the navigation application. In particular, the conversational interaction requires less cognitive input from the user and is therefore less distracting to the user, since the user does not need to physically view and physically select a route on a display of a device. Instead, a user can verbally refine and select a route whilst driving or otherwise operating a vehicle. As previously mentioned, conventional systems automatically provide a list of route options in response to a single query posed by a user. Consequently, conventional systems are strictly limited in the search/determination criteria applied to generate the list of route options by the user's single query, and are therefore greatly limited in their ability to refine the list of routes presented to the user. As a result, conventional systems can frustrate users by providing an overwhelming amount of possible routes, many of which are not optimized for the user's specific circumstances. By contrast, the techniques of the present disclosure eliminate these frustrating, overwhelming interactions with navigation applications by conversing with the user until the application has sufficient information to determine a refined set of optimal route suggestions that are each tailored to the user's specific circumstances. The refined set of optimal route suggestions also requires less computational resources to process and provide to a user for selection, since the refined set of routes contains fewer routes that the original set. In this way, a more computationally efficient technique is disclosed compared to conventional techniques.

One example embodiment of the techniques of this disclosure is a method in a computing device for determining places and routes through natural conversation. The method includes receiving, from a user, a speech input including a search query to initiate a navigation session; generating, by one or more processors, a set of navigation search results responsive to the search query, the set of navigation search results including a plurality of destinations or a plurality of routes corresponding to one or more destinations; providing, by the one or more processors, an audio request to the user for refining the set of navigation search results; in response to the audio request, receiving, from the user, a subsequent speech input including a refined search query; and providing, by the one or more processors, one or more refined navigation search results responsive to the refined search query including a subset of the plurality of destinations or the plurality of routes.

Another example embodiment is a computing device for determining places and routes through natural conversation. The computing device includes a user interface; one or more processors; and a computer-readable memory, which is optionally non-transitory, coupled to the one or more processors and storing instructions thereon that, when executed by the one or more processors, cause the computing device to: receive, from a user, a speech input including a search query to initiate a navigation session, generate a set of navigation search results responsive to the search query, the set of navigation search results including a plurality of destinations or a plurality of routes corresponding to one or more destinations, provide an audio request to the user for refining the set of navigation search results, in response to the audio request, receive, from the user, a subsequent speech input including a refined search query, and provide one or more refined navigation search results responsive to the refined search query including a subset of the plurality of destinations or the plurality of routes.

Yet another example embodiment is a computer-readable medium, which is optionally non-transitory, storing instructions for determining places and routes through natural conversation, that when executed by one or more processors cause the one or more processors to: receive, from a user, a speech input including a search query to initiate a navigation session; generate a set of navigation search results responsive to the search query, the set of navigation search results including a plurality of destinations or a plurality of routes corresponding to one or more destinations; provide an audio request to the user for refining the set of navigation search results; in response to the audio request, receive, from the user, a subsequent speech input including a refined search query; and provide one or more refined navigation search results responsive to the refined search query including a subset of the plurality of destinations or the plurality of routes.

Another example embodiment is a method in a computing device for determining places and routes through natural conversation. The method includes receiving input from a user to initiate a navigation session, generating one or more destinations or one or more routes responsive to the user input, and providing a request to the user for refining a response to the user input. In response to the request, the method includes receiving subsequent input from the user, and providing one or more updated destinations or one or more updated routes in response to the subsequent user input.

### BRIEF DESCRIPTION OF THE DRAWINGS

FIG. 1A is a block diagram of an example communication system in which techniques for determining places and routes through natural conversation can be implemented;

FIG. 1B illustrates an example vehicle interior in which a user may utilize the user computing device or the vehicle computing device of FIG. 1A to determine places and routes through natural conversation;

FIG. 2A illustrates an example conversation between a user and the user computing device of FIG. 1A in order to determine places and routes through natural conversation;

FIG. 2B illustrates a user input analysis sequence in order to output an audio request and a set of navigation search results;

FIG. 2C illustrates a subsequent user input analysis sequence in order to output a set of refined navigation search results;

FIG. 3A illustrates an example transition between a user providing a route acceptance input and a user computing device displaying navigation instructions corresponding to the accepted route;

FIG. 3B illustrates an example route update sequence in order to update navigation instructions provided to a user by prompting the user with an option to switch to an alternate route;

FIG. 4 is a flow diagram of an example method for determining places and routes through natural conversation, which can be implemented in a computing device, such as the user computing device of FIG. 1.

### DETAILED DESCRIPTION

### Overview

As previously discussed, navigation applications typically receive a user input and automatically generate a multitude of route options from which a user may choose. However, in such situations, it may be better to follow up with the user with clarifying questions or statements, thereby allowing the user to narrow down the set of possible routes in order to provide a reduced set of route choices. The techniques of the present disclosure accomplish this clarification by supporting conversational route configuration that (i) detects situations where follow-up questions (referenced herein as “audio requests”) would be beneficial and (ii) provides the user with opportunities to clarify their preferences in order to identify optimal routes. It would be appreciated techniques of the present disclosure may also accomplish the clarification and optimal route suggestion in a manner that is agnostic of user preferences. For example, a route suggestion that is objectively safer, quicker, or shorter may be provided based on the conversational route configuration.

Generally speaking, a user's computing device may generate a refined set of navigation search results based on a series of inputs received from the user as part of a conversational dialogue with the user computing device. More specifically, the user computing device may receive, from a user, a speech input including a search query to initiate a navigation session. The navigation session broadly corresponds to a set of navigation instructions intended to guide the user from a current location or specified location to a destination, and such navigation instructions may be rendered on a user interface for display to the user or audibly communicated through an audio output component of the user computing device. The user computing device may then generate a set of navigation search results responsive to the search query, and the set of navigation search results may include a plurality of destinations or a plurality of routes corresponding to one or more destinations.

At this point, the user computing device (e.g., via a navigation application), may determine that the set of navigation search results can/should be refined prior to providing the search results to the user. For example, the user computing device may determine that the number of route options included in the set of navigation search results is too large (e.g., exceeds a route presentation threshold), and would likely confuse and/or otherwise overwhelm the user, or would be too computationally expensive to provide the set of search results to the user. Additionally, or alternatively, the user computing device may determine that the optimal route included in the set of navigation instructions features potentially hazardous and/or otherwise unusual driving conditions, of which, the user should be made aware prior to or during the navigation session. In any event, when the user computing device determines that the user should be prompted with an audio request, the user computing device may provide an audio request for refining the set of navigation search results to the user.

Accordingly, and in response to the audio request, the user computing device may receive a subsequent speech input from the user that includes a refined search query. This refined search query may include keywords or other phrases that may directly correspond to keywords or phrases included as part of the audio request, such that the user computing device may refine the set of navigation search results based on the user's subsequent speech input. For example, an audio request provided to the user by the user computing device may prompt the user to specify the maximum desired travel time to the destination. In response, the user may state, “I don't want to be on the road for more than 30 minutes.” The user computing device may receive this subsequent speech input from the user, interpret that 30 minutes is the maximum desired travel time, and filter the set of navigation search results by eliminating routes with a projected travel time that exceeds 30 minutes. Thereafter, the user computing device may provide one or more refined navigation search results responsive to the refined search query, including a subset of the plurality of destinations or the plurality of routes.

In this manner, aspects of the present disclosure provide a technical solution to the problem of non-optimal route suggestions by automatically filtering route options based on a conversation between the user and the navigation application. Conventional systems automatically provide a list of route options in response to a single query posed by a user, and as a result, are strictly limited in the search/determination criteria applied to generate the list of route options and in their ability to refine the list of routes provided to the user. Such conventional systems typically frustrate users by providing an overwhelming amount of possible routes, many of which are not optimized for the user's specific circumstances. By contrast, the techniques of the present disclosure eliminate these frustrating, overwhelming interactions with navigation applications by conversing with the user until the application has sufficient information to determine a refined set of navigation search results that are each tailored to the user's specific circumstances. The techniques of the present disclosure provide a technical solution to the problem of optimizing computational resources when providing route suggestions by refining the possible routes through a conversation with the user.

Further, the present techniques improve the overall user experience when utilizing a navigation application, and more broadly, when receiving navigation instructions to a desired destination. The present techniques automatically determine refined sets of navigation search results that, in some examples, are specifically tailored/curated to a user's preferences, as determined through an intuitive and distraction-free conversation between the user and their computing device. This helps provide a more user friendly, relevant, and safe experience that increases user satisfaction with their travel plans, decreases user distraction while traveling to their desired destination, and decreases user confusion and frustration resulting from non-optimized and/or otherwise irrelevant/inappropriate navigation recommendations from conventional navigation applications. The present techniques thus enable a safer, more user-specific, and a more enjoyable navigation session to desired destinations.

### Example Hardware and Software Components

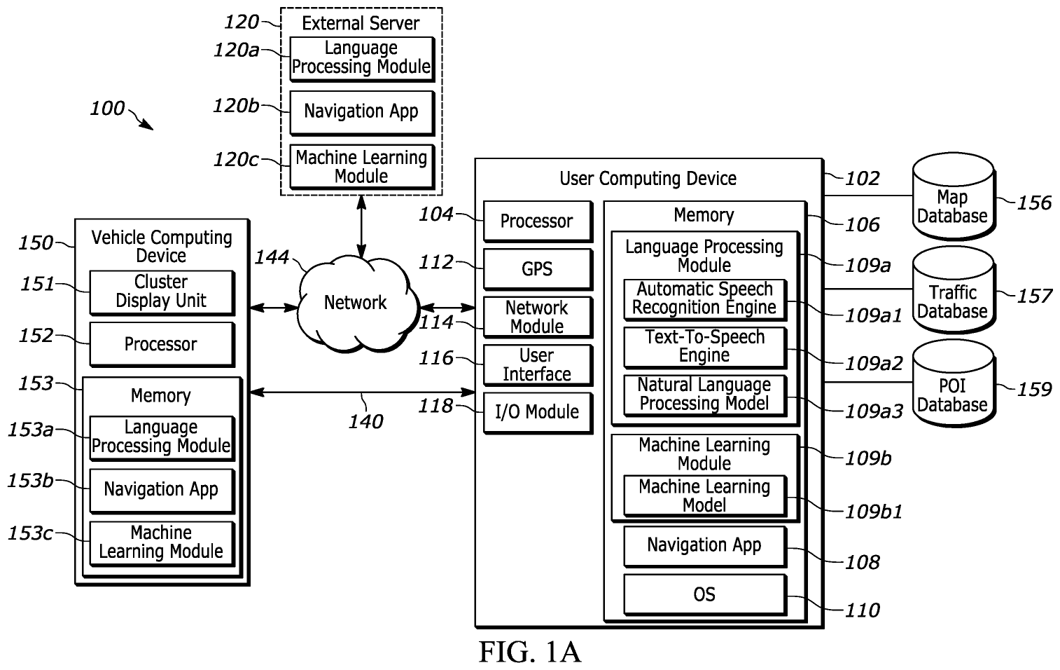

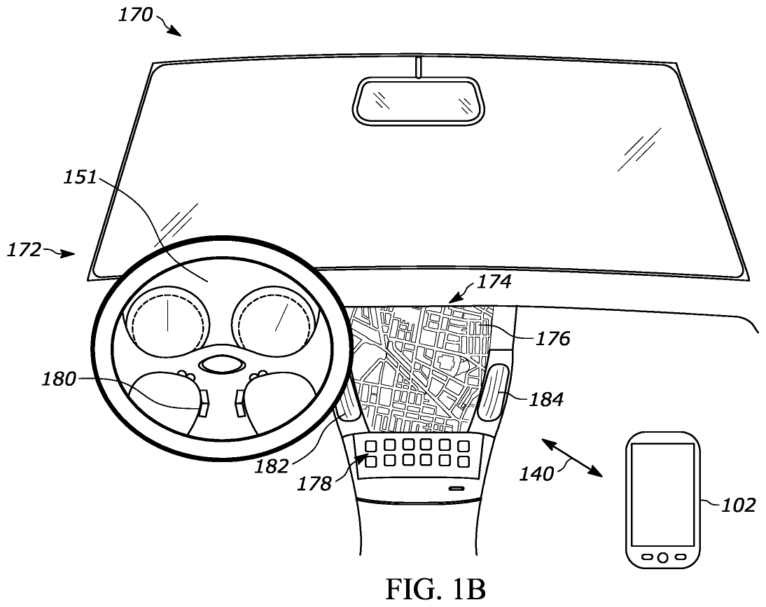

Referring first to FIG. 1A, an example communication system 100 in which techniques for determining places and routes through natural conversation can be implemented includes a user computing device 102. The user computing device 102 may be a portable device such as a smart phone or a tablet computer, for example. The user computing device 102 may also be a laptop computer, a desktop computer, a personal digital assistant (PDA), a wearable device such as a smart watch or smart glasses, etc. In some embodiments, the user computing device 102 may be removably mounted in a vehicle, embedded into a vehicle, and/or may be capable of interacting with a head unit of a vehicle to provide navigation instructions.

The user computing device 102 may include one or more processor(s) 104 and a memory 106 storing machine-readable instructions executable on the processor(s) 104. The processor(s) 104 may include one or more general-purpose processors (e.g., CPUs), and/or special-purpose processing units (e.g., graphical processing units (GPUs)). The memory 106 can be, optionally, a non-transitory memory and can include one or several suitable memory modules, such as random access memory (RAM), read-only memory (ROM), flash memory, other types of persistent memory, etc. The memory 106 may store instructions for implementing a navigation application 108 that can provide navigation directions (e.g., by displaying directions or emitting audio instructions via the user computing device 102), display an interactive digital map, request and receive routing data to provide driving, walking, or other navigation directions, provide various geo-located content such as traffic, points-of-interest (POIs), and weather information, etc.

Further, the memory 102 may include a language processing module 109a configured to implement and/or support the techniques of this disclosure for determining places and routes through natural conversation. Namely, the language processing module 109a may include an automatic speech recognition (ASR) engine 109a1 that is configured to transcribe speech inputs from a user into sets of text. Further, the language processing module 109a may include a text-to-speech (TTS) engine 109a2 that is configured to convert text into audio outputs, such as audio requests, navigation instructions, and/or other outputs for the user. In some scenarios, the language processing module 109a may include a natural language processing (NLP) model 109a3 that is configured to output textual transcriptions, intent interpretations, and/or audio outputs related to a speech input received from a user of the user computing device 102. It should be understood that, as described herein, the ASR engine 109a1 and/or the TTS engine 109a2 may be included as part of the NLP model 109a3 in order to transcribe user speech inputs into a set of text, convert text outputs into audio outputs, and/or any other suitable function described herein as part of a conversation between the user computing device 102 and the user.

Generally, the language processing module 109a may include computer-executable instructions for training and operating the NLP model 109a3. In general, the language processing module 109a may train one or more NLP models 109a3 by establishing a network architecture, or topology, and adding layers that may be associated with one or more activation functions (e.g., a rectified linear unit, softmax, etc.), loss functions and/or optimization functions. Such training may generally be performed using a symbolic method, machine learning (ML) models, and/or any other suitable training method. More generally, the language processing module 109a may train the NLP models 109a3 to perform two techniques that enable the user computing device 102, and/or any other suitable device (e.g., vehicle computing device 151) to understand the words spoken by a user and/or words generated by a text-to-speech program (e.g., TTS engine 109a2) executed by the processor 104: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (POS) tagging, parsing, lemmatization and stemming, stop-word removal, and/or any other suitable sub-task or combinations thereof. For example, using syntactic analysis, the NLP model 109a3 may generate textual transcriptions from the speech inputs from the user. Additionally, or alternatively, the NLP model 109a3 may receive such textual transcriptions as a set of text from the ASR engine 109a1 in order to perform semantic analysis on the set of text.

Semantic analysis generally involves analyzing text in order to understand and/or otherwise capture the meaning of the text. In particular, the NLP model 109a3 applying semantic analysis may study the meaning of each individual word contained in a textual transcription in a process known as lexical semantics. Using these individual meanings, the NLP model 109a3 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the NLP model 109a3 may generate one or more intent interpretations based on the textual transcriptions from the syntactic analysis.

In these aspects, the language processing module 109a may include an artificial intelligence (AI) trained conversational algorithm (e.g., the natural language processing (NLP) model 109a3) that is configured to interact with a user that is accessing the navigation app 108. The user may be directly connected to the navigation app 108 to provide verbal input/responses (e.g., speech inputs), and/or the user request may include textual inputs/responses that the TTS engine 109a2 (and/or other suitable engine/model/algorithm) may convert to audio inputs/responses for the NLP model 109a3 to interpret. When a user accesses the navigation app 108, the inputs/responses spoken by the user and/or generated by the TTS engine 109a2 (or other suitable algorithm) may be analyzed by the NLP model 109a3 to generate textual transcriptions and intent interpretations.

The language processing module 109a may train the one or more NLP models 109a3 to apply these and/or other NLP techniques using a plurality of training speech inputs from a plurality of users. As a result, the NLP model 109a3 may be configured to output textual transcriptions and intent interpretations corresponding to the textual transcriptions based on the syntactic analysis and semantic analysis of the user's speech inputs.

In certain aspects, one or more types of machine learning (ML) may be employed by the language processing module 109a to train the NLP model(s) 109a3. The ML may be employed by the ML module 109b, which may store a ML model 109b1. The ML model 109b1 may be configured to receive a set of text corresponding to a user input, and to output an intent and destination based on the set of text. The NLP model(s) 109a3 may be and/or include one or more types of ML models, such as the ML model 109b1. More specifically, in these aspects, the NLP model 109a3 may be or include a machine learning model (e.g., a large language model (LLM)) trained by the ML module 109b using one or more training data sets of text in order to output one or more training intents and one or more training destinations, as described further herein. For example, artificial neural networks, recurrent neural networks, deep learning neural networks, a Bayesian model, and/or any other suitable ML model 109b1 may be used to train and/or otherwise implement the NLP model(s) 109a3. In these aspects, training may be performed by iteratively training the NLP model(s) 109a3 using labeled training samples (e.g., training user inputs).

In instances where the NLP model(s) 109a3 is an artificial neural network, training of the NLP model(s) 109a3 may produce byproduct weights, or parameters which may be initialized to random values. The weights may be modified as the network is iteratively trained, by using one of several gradient descent algorithms, to reduce loss and to cause the values output by the network to converge to expected, or “learned”, values. In embodiments, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In embodiments, multiple artificial neural networks may be separately trained and operated, and/or separately trained and operated in conjunction.

In embodiments, the one or more NLP models 109a3 may include an artificial neural network having an input layer, one or more hidden layers, and an output layer. Each of the layers in the artificial neural network may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of artificial neural networks are possible. For example, the input layer may correspond to input parameters that are given as full sentences, or that are separated according to word or character (e.g., fixed width) limits. The input layer may correspond to a large number of input parameters (e.g., one million inputs), in some embodiments, and may be analyzed serially or in parallel. Further, various neurons and/or neuron connections within the artificial neural network may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some embodiments and/or scenarios, the output layer includes only a single output.

It is noted that although FIG. 1A illustrates the navigation application 108 as a standalone application, the functionality of the navigation application 108 also can be provided in the form of an online service accessible via a web browser executing on the user computing device 102, as a plug-in or extension for another software application executing on the user computing device 102, etc. The navigation application 108 generally can be provided in different versions for different operating systems. For example, the maker of the user computing device 102 can provide a Software Development Kit (SDK) including the navigation application 108 for the Android™ platform, another SDK for the iOS™ platform, etc.

The memory 106 may also store an operating system (OS) 110, which can be any type of suitable mobile or general-purpose operating system. The user computing device 102 may further include a global positioning system (GPS) 112 or another suitable positioning module, a network module 114, a user interface 116 for displaying map data and directions, and input/output (I/O) module 118. The network module 114 may include one or more communication interfaces such as hardware, software, and/or firmware of an interface for enabling communications via a cellular network, a Wi-Fi network, or any other suitable network such as a network 144, discussed below. The I/O module 118 may include I/O devices capable of receiving inputs from, and providing outputs to, the ambient environment and/or a user. The I/O module 118 may include a touch screen, display, keyboard, mouse, buttons, keys, microphone, speaker, etc. In various implementations, the user computing device 102 can include fewer components than illustrated in FIG. 1A or, conversely, additional components.

The user computing device 102 may communicate with an external server 120 and/or a vehicle computing device 150 via a network 144. The network 144 may include one or more of an Ethernet-based network, a private network, a cellular network, a local area network (LAN), and/or a wide area network (WAN), such as the Internet. The navigation application 108 may transmit map data, navigation directions, and other geo-located content from a map database 156 to the vehicle computing device 150 for display on the cluster display unit 151. Additionally, or alternatively, the navigation application 108 may access map, navigation, and geo-located content that is stored locally at the user computing device 102, and may access the map database 156 periodically to update the local data or during navigation to access real-time information, such as real-time traffic data. Moreover, the user computing device 102 may be directly connected to the vehicle computing device 150 through any suitable direct communication link 140, such as a wired connection (e.g., a USB connection).

In certain aspects, the network 144 may include any communication link suitable for short-range communications and may conform to a communication protocol such as, for example, Bluetooth™ (e.g., BLE), Wi-Fi (e.g., Wi-Fi Direct), NFC, ultrasonic signals, etc. Additionally, or alternatively, the network 144 may be, for example, Wi-Fi, a cellular communication link (e.g., conforming to 3G, 4G, or 5G standards), etc. In some scenarios, the network 144 may also include a wired connection.

The external server 120 may be a remotely located server that includes processing capabilities and executable instructions necessary to perform some/all of the actions described herein with respect to the user computing device 102. For example, the external server 120 may include a language processing module 120a that is similar to the language processing module 109a included as part of the user computing device 102, and the module 120a may include one or more of the ASR engine 109a1, the TTS engine 109a2, and/or the NLP model 109a3. The external server 120 may also include a navigation app 120b and a ML module 120c that are similar to the navigation app 108 and ML module 109b included as part of the user computing device 102.

The vehicle computing device 150 includes one or more processor(s) 152 and a memory 153 storing computer-readable instructions executable by the processor(s) 152. The memory 153 may store a language processing module 153a, a navigation application 153b, and a ML module 153c that are similar to the language processing module 153a, the navigation application 108, and the ML module 109b, respectively. The navigation application 153b may support similar functionalities as the navigation application 108 from the vehicle-side and may facilitate rendering of information displays, as described herein. For example, in certain aspects, the user computing device 102 may provide the vehicle computing device 150 with an accepted route that has been accepted by a user, and the corresponding navigation instructions to be provided to the user as part of the accepted route. The navigation application 153b may then proceed to render the navigation instructions within the cluster unit display 151 and/or to generate audio outputs that verbally provide the user with the navigation instructions via the language processing module 153a.

In any event, the user computing device 102 may be communicatively coupled to various databases, such as a map database 156, a traffic database 157, and a point-of-interest (POI) database 159, from which the user computing device 102 can retrieve navigation-related data. The map database 156 may include map data such as map tiles, visual maps, road geometry data, road type data, speed limit data, etc. The traffic database 157 may store historical traffic information as well as real-time traffic information. The POI database 159 may store descriptions, locations, images, and other information regarding landmarks or points-of-interest. While FIG. 1A depicts databases 156, 157, and 159, the user computing device 102, the vehicle computing device 150, and/or the external server 120 may be communicatively coupled to additional, or conversely, fewer, databases. For example, the user computing device 102 and/or the vehicle computing device 150 may be communicatively coupled to a database storing weather data.

Turning to FIG. 1B, the user computing device 102 may transmit information for rendering/display of navigation instructions within a vehicle environment 170. The user computing device 102 may be located within a vehicle 172, and may be a smartphone. However, while FIG. 1B depicts the user computing device 102 as a smartphone, this is for case of illustration only, and the user computing device 102 may be any suitable type of device and may include any suitable type of portable or non-portable computing devices.

In any event, the vehicle 172 may include a head unit 174, which in some aspects, may include and/or otherwise house the user computing device 102. Even if the head unit 174 does not include the user computing device 102, the device 102 may communicate (e.g., via a wireless or wired connection) with the head unit 174 to transmit navigation information, such as maps or audio instructions and/or information displays to the head unit 174 for the head unit 174 to display or emit. Additionally, the vehicle 172 includes the cluster display unit 151, which may display information transmitted from the user computing device 102. In certain aspects, a user may interact with the user computing device 102 by interacting with head unit controls. In addition, the vehicle 172 may provide the communication link 140, and the communication link 140, for example, may include a wired connection to the vehicle 172 (e.g., via a USB connection) through which the user computing device 102 may transmit the navigation information and the corresponding navigation instruction for rendering within the cluster display unit 151, the display 176, and/or as audio output through speakers 184.

Accordingly, the head unit 174 may include the display 176 for outputting navigation information such as a digital map. Of course, the cluster display unit 151 may also display such navigation information, including a digital map. Such a map rendered within the cluster display unit 151 may provide a driver of the vehicle 172 with more optimally located navigation instructions, and as a result, the driver may not be forced to look away from the active roadway as much while driving in order to safely navigate to their intended destination. Nevertheless, the display 176 in some implementations includes a software keyboard for entering text input, which may include the name or address of a destination, point of origin, etc.

Hardware input controls 178 and 180 on the head unit 174 and the steering wheel, respectively, can be used for entering alphanumeric characters or to perform other functions for requesting navigation directions. For example, the hardware input controls 178, 180 may be and/or include rotary controls (e.g., a rotary knob), trackpads, touchscreens, and/or any other suitable input controls. The head unit 174 also can include audio input and output components such as a microphone 182 and speakers 184, for example. As an example, the user computing device 102 may communicatively connect to the head unit 174 (e.g., via Bluetooth™, WiFi, cellular communication protocol, wired connection, etc.) or may be included in the head unit 174. The user computing device 102 may present map information via the cluster display unit 151, emit audio instructions for navigation via the speakers 184, and receive inputs from a user via the head unit 174 (e.g., via a user interacting with the input controls 178 and 180, the display 176, or the microphone 182).

### Example Conversations/Analysis Performed to Determine Refined Navigation Search Results

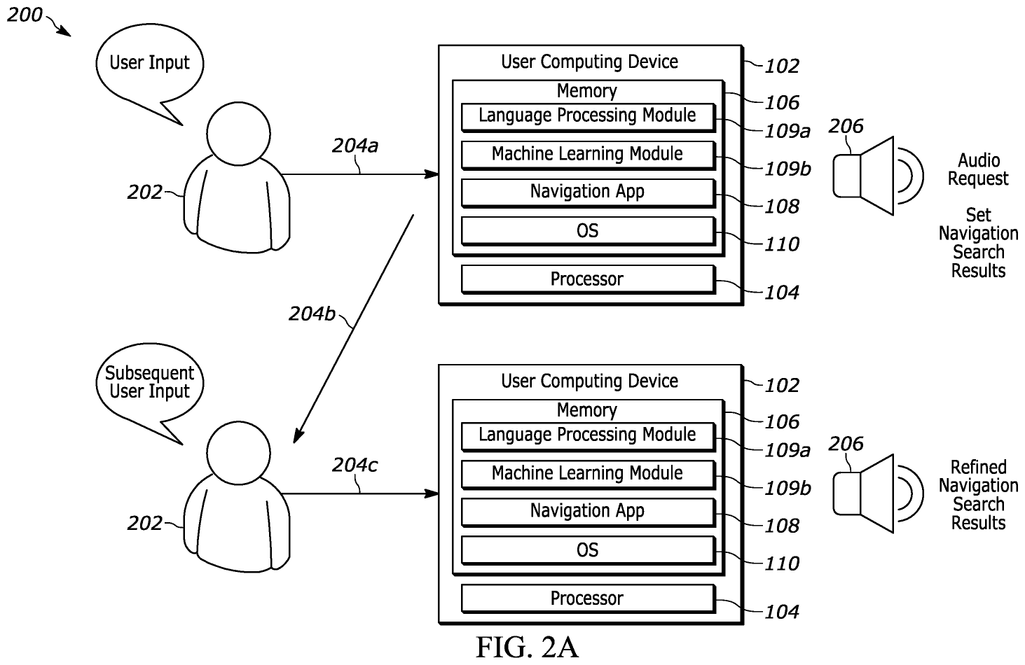

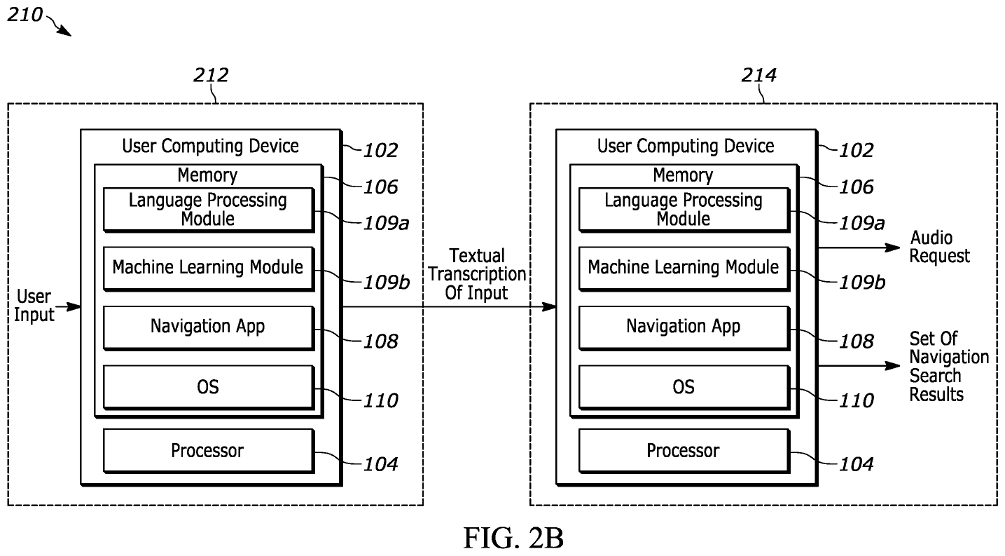

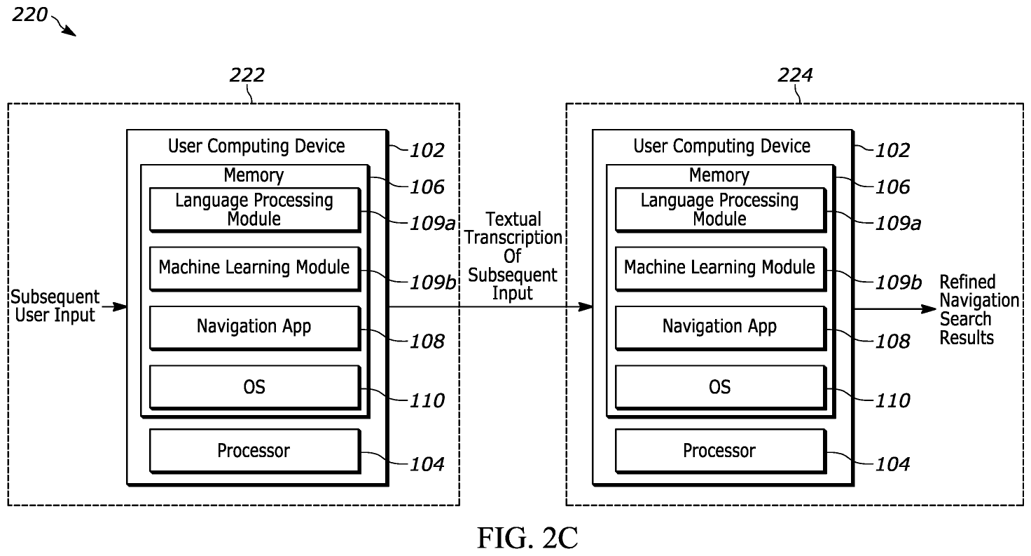

The techniques of this disclosure for determining routes and places through natural conversation are discussed below with reference to the conversation flows and processing workflows illustrated in FIGS. 2A-2C. Throughout the description of FIGS. 2A-2C, actions described as being performed by the user computing device 102 may, in some implementations, be performed by the external server 120, the vehicle computing device 150, and/or may be performed by the user computing device 102, the navigation server 120, and/or the vehicle computing device 150 in parallel. For example, the user computing device 102, the navigation server 120, and/or the vehicle computing device 150 may utilize the language processing module 109a, 120a, 153a and/or the machine learning module 109b, 120c, 153c to determine routes and places through natural conversation with the user.

In particular FIG. 2A illustrates an example conversation 200 between a user 202 and the user computing device 102 of FIG. 1A in order to determine places and routes through natural conversation. The user 202 may audibly converse with the user computing device 102, which may prompt the user 202 for clarification, in order to determine a refined set of navigation search results that enable the user 202 to travel to the user's 202 desired destination. Namely, the user 202 may provide a user input to the user computing device 102 (transmission to the user computing device 102 illustrated as 204a). The user input may generally include a user's 202 desired destination, as well as additional criteria the user 202 includes that is relevant to the user's 202 desired routing to the destination. For example, the user 202 may state “Navigate to the ABC hotel,” and the user 202 may additionally state that “I do not want to drive for longer than 25 minutes.” Thus, the user input includes a destination (ABC hotel) and additional criteria (travel time less than or equal to 25 minutes).

Using this user input, the user computing device 102 may generate an initial set of navigation search results that satisfy one or both of the user's 202 criteria. For example, the initial set of navigation search results may include multiple routes to one or more ABC hotels, and/or multiple routes leading to different hotels/accommodations that are less than or equal to 25 minutes away. In any event, the user computing device 102 may determine that the number of candidate routes is too large for providing to the user 202, and/or may otherwise determine that the set of navigation search results should be filtered in order to provide the user 202 with a refined set of navigation search results.

In that case, the user computing device 102 may generate an audio request that is output to the user 202 (transmission to the user 202 illustrated as 204b) via a speaker 206 that may be integrated as part of the user computing device 102 (e.g., part of the I/O module 118). The audio request may prompt the user 202 to provide additional criteria and/or details corresponding to the user's 202 desired destination and/or route in order for the user computing device 102 (e.g., via the machine learning module 109b) to refine the set of navigation search results. Continuing the above example, the audio request transmitted to the user 202 via speaker 206 may state “What is the address of the ABC hotel where you are staying?.” and the audio request may further state “Several routes include traveling on toll roads. Is that okay?” In this manner, the user computing device 102 may request additional information from the user 202 in order to filter (e.g., eliminate) routes that do not comply and/or otherwise fail to satisfy the additional criteria that may be provided by the user 202 in response to the audio request.

However, the audio request may provide a litany of various clarification options to the user. For example, the user 202 may be traveling in Switzerland and may provide a user input by speaking “navigate to a nearby hiking spot.” The user computing device 102 may generate a large number of route options in the set of navigation search results that include several different options to reach a hiking trail from a car parking lot, and the device 102 may respond to the user 202 with an audio request, stating “Some of the top rated options require taking a cable car from the parking lot, would you be willing to do that? The total journey time would likely be under 30 minutes.” Thus, the user computing device 102 may provide an audio request to the user 202 that may quickly eliminate many route options based on the user's 202 response indicating whether or not taking a cable car from the parking lot is acceptable.

As another example, the user computing device 102 may provide an audio request that includes a suggestion to help the user 202 decide on an optimal route in the set of navigation search results. In this example, the user 202 may arrive at an airport, and may want to navigate to their hotel by asking the user computing device 102 “Give me directions to ABC hotel.” The user computing device 102 may respond with a few different route proposals along with a top candidate by stating “The route I recommend is the shortest one, but it involves driving 10 miles on a single track road.” If the user 202 is comfortable driving for 10 miles on a single track road, then the user 202 may accept the proposed route, thereby ending the route search. However, if the user 202 declines the proposed route, then the user computing device 102 may eliminate the proposed route as well as all routes that include traveling on a single track road for at least 10 miles. Thus, suggesting a proposed route with specified criteria may enable the user computing device 102 to refine the set of navigation search results without directly prompting (and potentially distracting) the user 202.

As yet another example, the audio request may be configured to provide conversational clarification during a navigation session. Similar to the above example, the user 202 may be navigating to their hotel from the airport, and while the user 202 is en route, the user 202 encounters a potential detour along the way which would take a similar amount of time but has different properties. When approaching the detour, the user computing device 102 may prompt the user 202 with an audio request stating “There is an alternate route at exit 213A with a similar ETA. It is a shorter distance but has some temporary construction which may cause a 3-minute delay. Would you like to take the alternate route?” In response, the user 202 may either accept or decline the alternate route, and the user computing device 102 may continue with the original route or switch to the alternate route, as appropriate. Thus, in this example, the set of navigation search results may comprise the original route and the alternate route, and the audio request may prompt the user 202 to filter the set of navigation search results by determining which of the two routes the user 202 prefers. In this manner, the audio requests provided by the user computing device 102 may actively/continually search for and/or filter sets of navigation search results before/during navigation sessions in order to ensure that the user 202 receives an optimal routing experience to their destination.

Further, it should be noted that the user computing device 102 may generally allow the user 202 several seconds (e.g., 5-10 seconds) to respond following transmission of the audio request through the speaker 206 in order to give the user 202 enough time to think of a proper response without continually listening to the interior of the automobile. By default, the user computing device 102 may not activate a microphone and/or other listening device (e.g., included as part of the I/O module 118) while running the navigation app 108, and/or while processing information received through the microphone by, or in accordance with, for example, the processor 104, the language processing module 109a, the machine learning module 109b, and/or the OS 110. Thus, the user computing device 102 may not actively listen to a vehicle interior during a navigation session and/or at any other time, except when the user computing device 102 provides an audio request to the user 202, to which, the user computing device 102 may expect a verbal response from the user 202 within several seconds of transmission.

In any event, the user 202 may hear the audio request, and in response, may provide a subsequent user input (transmission to the user computing device 102 illustrated as 204c). The subsequent user input may generally include additional route/destination criteria that is based on the requested information included as part of the audio request provided by the user computing device 102. Continuing a prior example, the user 202 may provide a subsequent user input to the audio request “What is the address of the ABC hotel where you are staying?” and “Several routes include traveling on toll roads. Is that okay?” by stating “The ABC hotel is at 123 Main Street, Chicago, IL,” and “No, I would prefer to avoid toll roads.” Thus, in this example, the user 202 provides additional location information related to the desired destination and routing information to exclude toll roads that the user computing device 102 may use to refine the set of navigation search results. Accordingly, the user computing device 102 may receive the subsequent user input, and may proceed to generate a refined set of navigation search results. The user computing device 102 may provide this refined set of navigation search results to the user 202 as an audio output (e.g., by speaker 206), as a visual output on a display screen (e.g., cluster display unit 151, display 176), and/or as a combination of audio/visual output.

In order to provide a better understanding of the processing performed by the user computing device 102 as described in FIG. 2A, FIG. 2B illustrates a user input analysis sequence 210 in order to output the audio request and the set of navigation search results. The user input analysis sequence 210 generally includes the user computing device 102 analyzing/manipulating user inputs during two distinct periods 212, 214 in order to generate two distinct outputs. Namely, during the first period 212, the user computing device 102 receives the user input, and proceeds to utilize the language processing module 109a to generate the textual transcription of the user input. Thereafter, during the second period 214, the user computing device utilizes the language processing module 109a and/or the machine learning module 109b to analyze the textual transcription of the user input in order to output the audio request and/or the set of navigation search results.

More specifically, during the first period 212, the user computing device 102 receives the user input through an input device (e.g., microphone as part of the I/O module 118). The user computing device 102 then utilizes the processor 104 to execute instructions included as part of the language processing module 109a to transcribe the user input into a set of text. The user computing device 102 may cause the processor 104 to execute instructions comprising, for example, an ASR engine (e.g., ASR engine 109a1) in order to transcribe the user input from the speech-based input received by the I/O module 118 into the textual transcription of the user input. Of course, as previously mentioned, it should be appreciated that the execution of the ASR engine to transcribe the user input into the textual transcription (and any other actions described in reference to FIGS. 2B and 2C) may be performed by the user computing device 102, the external server 120, the vehicle computing device 150, and/or any other suitable component or combinations thereof.

This transcription of the user input may then be analyzed during the second period 214, for example, by the processor 104 executing instructions comprising the language processing module 109a and/or the machine learning module 109b in order to output the audio request and/or the set of navigation search results. In particular, the instructions comprising the language processing module 109a and/or the machine learning module 109b may cause the processor 104 to interpret the textual transcription in order to determine a user intent along with values corresponding to a destination and/or other constraints. For example, the user intent may include traveling to a desired destination, the destination value may correspond to a specific location (e.g., Chicago, IL) or a general location (e.g., nearby hiking trails), and the other constraints may include any other details corresponding to the user's intent (e.g., traveling “by car”, “under 10 miles away”, etc.).

In order to determine a destination value from the user's input when the destination is generally described (e.g., “nearby restaurant”), the user computing device 102 may first parse and extract this destination information from the user's input. The user computing device 102 may then access a database (e.g., map database 156, POI database 159) or other suitable repository in order to search for a corresponding location by anchoring the search on the user's current location and/or viewport. The user computing device 102 may then identify candidate destinations and routes to each candidate destination based on similarities between the locations in the repository and the destination determined from the user's input, thereby creating an initial set of navigation search results.

However, prior to determining whether or not to generate an audio request, the user computing device 102 may prune this initial set of navigation search results by eliminating candidate destinations and routes that do not match and/or otherwise properly correspond to the other details corresponding to the user's intent. For example, if a candidate destination is further away than the user specified as a maximum distance in the user input, then the candidate destination may be eliminated from the initial set of navigation search results. Additionally, each destination/route may receive a score corresponding to, for example, the overall similarity of the destination/route to the values extracted from the user input.

When the user computing device 102 determines and filters/prunes the initial set of navigation search results to generate the set of navigation search results, the device 102 may proceed to determine whether or not to provide an audio output to the user. The user computing device 102 may make this determination based on several criteria, such as (i) the total number of routes/destinations that would be provided to the user as part of the set of navigation search results, (ii) the device type and/or surface type (e.g., smartphone, tablet, wearable device, etc.) that the user is using to receive the navigation instructions, (iii) an entry point and/or input type used by the user to input the user input (e.g., speech-based input, touch-based input), (iv) whether or not the scores corresponding to the destinations/routes included in the set of navigation results are sufficiently high (e.g., relative to a score threshold), and/or any other suitable determination criteria or combinations thereof.

For example, the user computing device 102 may determine that the total number of routes included as part of the set of navigation search results is twenty, and a route presentation threshold may be fifteen. In some examples the route presentation threshold, is set based on a determination of the computational expense involved in providing a set of results. For example, in this example, providing a set of sixteen results is past the threshold and would require a larger amount of computational resources to provide this set of results, compared to a set of results that are less than the threshold amount. As a result, the user computing device 102 compares the total number of routes to the route presentation threshold to determine that the total number of routes does not satisfy the route presentation threshold, and that an audio request should be generated. Accordingly, if any of the above criteria are applied by the user computing device 102, and any of the applied criteria fail to satisfy their respective thresholds (e.g., route presentation threshold, score threshold) and/or have respective values (e.g., device type, input type) that require an audio request, the device 102 may generate an audio request.

In response to determining that an audio request should be generated, the user computing device 102 may proceed to generate an audio request using, for example, the language processing module 109a. The user computing device 102 may generally proceed to generate the audio request by considering which audio request would most reduce the number of destinations/routes included in the set of navigation search results. Namely, the user computing device 102 may analyze the attributes corresponding to each destination/route, determine which attributes are most common amongst the destinations/routes included in the set of navigation search results, and may generate an audio request based on one or more of these most common attributes.

As an example, a set of navigation search results may include twenty route options to a particular destination, and each route option may primarily differ from every other route option in the distance traveled to reach the particular destination. Thus, the user computing device 102 may generate an audio request prompting the user to provide a distance requirement in order to most efficiently refine the set of navigation search results by eliminating the routes that fail to satisfy the user's distance requirement.

As another example, the set of navigation search results may include eight route options to a particular destination, and each route option may primarily differ from every other route option in the road types (e.g., freeways, country roads, scenic routes, city streets) on which the user may travel to reach the particular destination. Thus, the user computing device 102 may generate an audio request prompting the user to provide a road type preference in order to most efficiently refine the set of navigation search results by eliminating the routes that fail to satisfy the user's road type preference.

The user computing device 102 may generate the text of the audio request by utilizing the language processing module 109a, and in certain aspects, a large language model (LLM) (e.g., language model for dialogue applications (LaMDA)) (not shown) included as part of the language processing module 109a. Such an LLM may be conditioned/trained to generate the audio request text based on the particular most common attributes of the set of navigation search results, and/or the LLM may be trained to receive a natural language representation of the candidate routes/destinations as input and to output a set of text representing the audio request based on the most common attributes.

In any event, when the user computing device 102 fully generates the text of the audio request, the device 102 may proceed to synthesize the text into speech for audio output of the request to the user. In particular, the user computing device 102 may transmit the text of the audio output to a TTS engine (e.g., TTS engine 109a2) in order to audibly output the audio request through a speaker (e.g., speaker 206), so that the user may hear and interpret the audio output. Additionally, or alternatively, the user computing device 102 may also visually prompt the user by displaying the text of the audio request on a display screen (e.g., cluster display unit 151, display 176), so that the user may interact (e.g., click, tap, swipe, etc.) with the display screen and/or verbally respond to the audio request.

When the user receives the audio request from the user computing device 102, the user may provide a subsequent user input. This user computing device 102 may receive this subsequent user input, and proceed to refine the set of navigation search results, as illustrated in FIG. 2C. More specifically, FIG. 2C illustrates a subsequent user input analysis sequence 220 in order to output a set of refined navigation search results. The subsequent user input analysis sequence 220 generally includes the user computing device 102 analyzing/manipulating subsequent user inputs during two distinct periods 222, 224 in order to generate two distinct outputs. Namely, during the first period 222, the user computing device 102 receives the subsequent user input, and proceeds to utilize the language processing module 109a to generate the textual transcription of the subsequent user input. Thereafter, during the second period 224, the user computing device utilizes the language processing module 109a and/or the machine learning module 109b to analyze the textual transcription of the subsequent user input in order to output the refined set of navigation search results.

More specifically, during the first period 222, the user computing device 102 receives the user input through an input device (e.g., microphone as part of the I/O module 118). The user computing device 102 then utilizes the processor 104 to execute instructions included as part of the language processing module 109a to transcribe the subsequent user input into a set of text. The user computing device 102 may cause the processor 104 to execute instructions comprising, for example, the ASR engine (e.g., ASR engine 109a1) in order to transcribe the subsequent user input from the speech-based input received by the I/O module 118 into the textual transcription of the subsequent user input.

This transcription of the subsequent user input may then be analyzed during the second period 224, for example, by the processor 104 executing instructions comprising the language processing module 109a and/or the machine learning module 109b in order to output the refined set of navigation search results. In particular, the instructions comprising the language processing module 109a and/or the machine learning module 109b may cause the processor 104 to interpret the textual transcription of the subsequent user input in order to determine a subsequent user intent along with values corresponding to a refined destination value and/or other constraints. For example, the subsequent user intent may include determining whether or not the subsequent user input is related to the audio request, the refined destination value may correspond to a specific location (e.g., Chicago, IL) or a general location (e.g., nearby hiking trails), and the other constraints may include any other details corresponding to the subsequent user intent (e.g., traveling “by car”, “under 10 miles away”, etc.).

When the user computing device 102 receives the subsequent user input and determines the subsequent user intent and refined destination values and/or other constraints, the device 102 may refine/filter the set of navigation search results by eliminating candidate destinations and routes that do not match and/or otherwise properly correspond to the other details corresponding to the subsequent user intent, refined destination values, and/or other constraints. Additionally, each destination/route included in the set of navigation search results may receive a score (e.g., from the machine learning module 109b) corresponding to, for example, the overall similarity of the destination/route to the values extracted from the subsequent user input. As an example, if a candidate route receives a score of 35 due to relative non-similarity to the values extracted from the subsequent user input, and the score threshold to remain part of the set of navigation results is 75, then the candidate route may be eliminated from the set of navigation search results.

Generally speaking, the user computing device 102 may repeat the actions described herein in reference to FIGS. 2B and 2C any suitable number of times in order to provide the user with a refined set of navigation search results. For example, after receiving the subsequent user input, the user computing device 102 may determine that a subsequent audio output should be provided to the user. Thus, in this example, the user computing device 102 may proceed to generate a subsequent audio request for the user, as described above in reference to FIG. 2B. The user computing device 102 may then receive yet another user input in response to the subsequent audio request, and may proceed to further refine the set of navigation search results until the criteria used by the device 102 to determine whether or not to generate an audio request are satisfied.

Regardless, when the user computing device 102 determines that all criteria corresponding to generating an audio request are satisfied, the device 102 may determine that the set of navigation search results are a refined set of navigation search results suitable for providing to the user. Accordingly, the user computing device 102 may proceed to provide the refined set of navigation search results to the user as an audio output and/or as a visual display. The refined set of navigation search results may include any suitable information corresponding to the respective routes when provided to the user, such as, total distance traveled, total travel time, number of roadway changes/turns, and/or any other suitable information or combinations thereof. Moreover, all information included as part of each route of the refined set of navigation search results may be provided to the user as an audio output (e.g., via speaker 206) and/or as a visual display on a display screen of any suitable device (e.g., I/O module 118, cluster display unit 151, display 176).

Of course, the user may determine that the set of navigation search results should be further refined, and may independently provide (e.g., without prompting from the user computing device 102) an input to the user computing device 102 to that effect. In certain aspects, the user may provide a user input with a particular trigger phrase or word that causes the user computing device 102 to receive user input for a certain duration following the user input with the trigger phrase/word. The user may initialize input collection of the user computing device 102 in this, or a similar manner, and the device 102 may proceed to receive and interpret the user input in a similar manner as previously described in reference to FIGS. 2A-2C. For example, the user may independently say “I'd prefer a shorter distance route, and am willing to drive on a single track road.” The user computing device 102 may receive this user input, and may proceed to refine the set of navigation search results for providing to the user, as previously described.

### Example Conversations/Analysis Performed to Provide Navigation Instructions

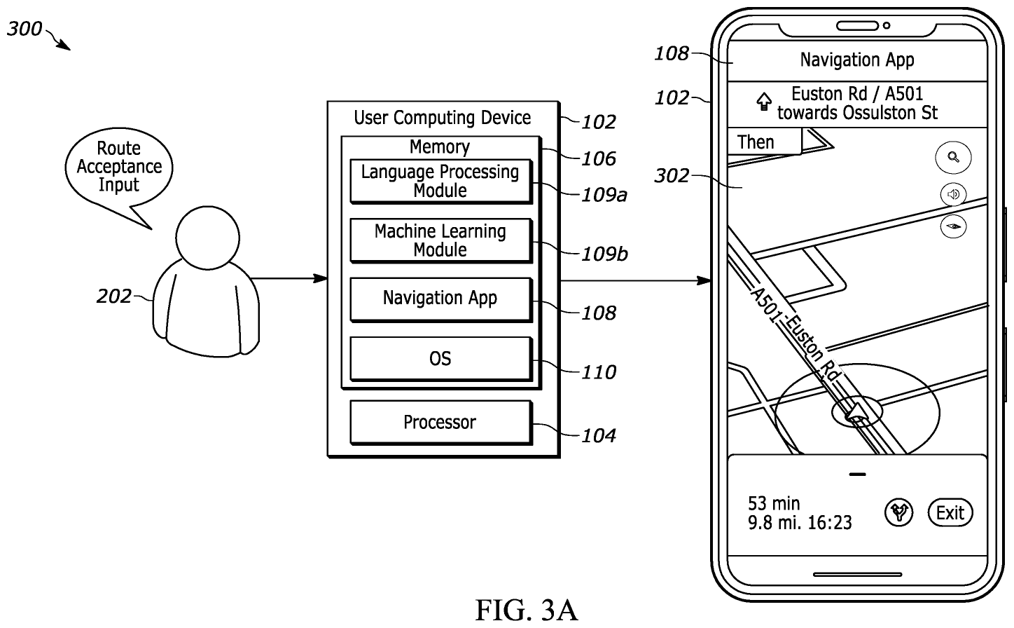

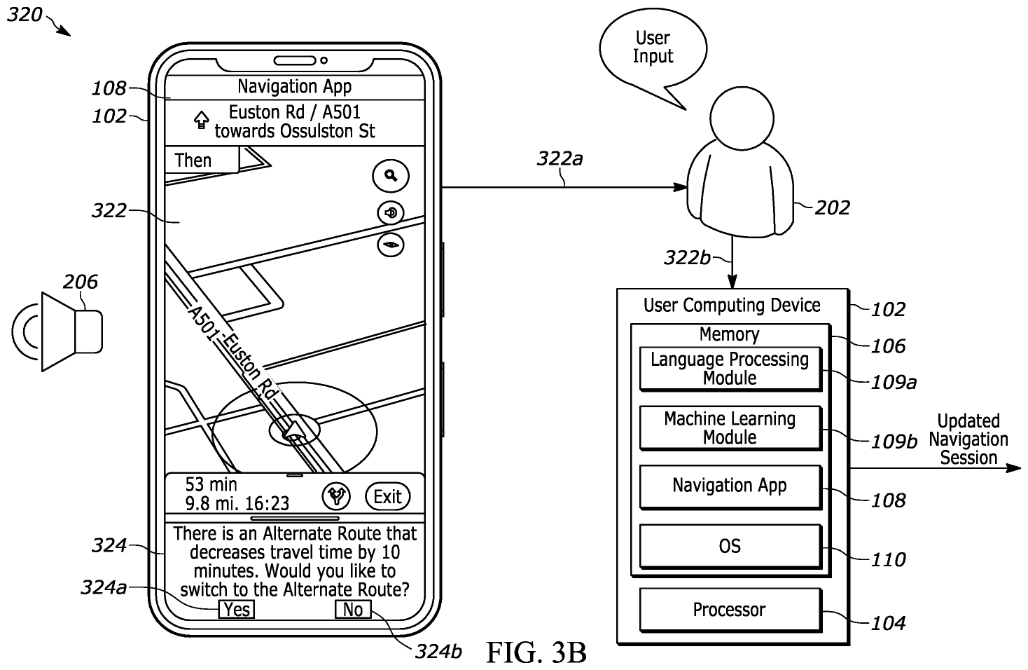

When the user computing device 102 has successfully generated the refined set of navigation search results, the user may examine the results to determine an optimal route to the desired destination. To illustrate the actions performed by the user computing device 102 as part of the route acceptance process, FIGS. 3A and 3B illustrate example route acceptance and route adjustment sequences wherein the user provides input to select/adjust a route included as part of the refined set of navigation search results. As previously mentioned, each route included as part of the refined set of navigation search results includes turn-by-turn directions to a destination as part of a navigation session. As described herein, the user may provide input regarding acceptance and/or adjustments of routes included in the refined set of navigation search results, such that the turn-by-turn directions provided by the user computing device 102 during a navigation session may also change corresponding to the user's inputs regarding a currently accepted route.

More specifically, FIG. 3A illustrates an example transition 300 between a user 202 providing a route acceptance input and a user computing device 102 displaying navigation instructions corresponding to the accepted route. The user 202 may provide a route acceptance input that indicates acceptance of a route included as part of the refined set of navigation search results to the user computing device 102. The user computing device 102 may then receive the route acceptance input, and proceed to initiate a navigation session that includes turn-by-turn navigation instructions corresponding to the accepted route. Accordingly, the user computing device 102 may proceed to provide verbal turn-by-turn instructions to the user 202, as well as rendering the turn-by-turn instructions on a display screen 302 of the device 102 for viewing by the user 202.

During the navigation session, the user computing device 102 may display, via the display screen 302, a map depicting a location of the user computing device 102, a heading of the user computing device 102, an estimated time of arrival, an estimated distance to the destination, an estimated travel time to the destination, a current navigation direction, one or more upcoming navigation directions of the set of navigation instructions corresponding to the accepted route, one or more user-selectable options for changing the display or adjusting the navigation directions, etc. The user computing device 102 may also emit audio instructions corresponding to the set of navigation instructions.

As an example, the user computing device 102 may provide the user 202 with a refined set of navigation search results that includes three candidate routes to the user's 202 desired destination. The user 202 may provide the route acceptance input indicating that the user 202 desires to take the first candidate route included as part of the refined set of navigation search results. The user computing device 102 may receive this route acceptance input from the user 202, and may proceed to provide a first navigation instruction included as part of the first candidate route (referenced herein in this example as the “accepted route”) and render a map on the display screen 302 that includes a visual representation of the first navigation instruction. As the user 202 travels along the accepted route, the user computing device 102 may provide sequential navigation instructions (e.g., first, second, third) to the user 202 verbally and visually when the user 202 approaches each waypoint along the accepted route, in order to enable the user 202 to follow the accepted route. When the user 202 reaches the destination at the end of the accepted route, the user computing device 102 may deactivate the navigation session.

However, in certain circumstances, the user 202 may desire and/or be forced to change from an accepted route to an alternate route. FIG. 3B illustrates an example route update sequence 320 in order to update navigation instructions provided to a user 202 by prompting the user 202 with an option to switch to an alternate route. In particular, the user computing device 102 may be actively engaged in a navigation session initiated by the user 202 when the user computing device 102 determines that an alternate route may be a more optimal route than the accepted route. The user computing device 102 may make such a determination based on, for example, updated traffic information along the accepted route (e.g., from traffic database 157), and/or any other suitable information

Based on this determination, the user computing device 102 may generate an alternate route output that provides (transmission to the user 202 indicated by 322a) the user 202 with the option to adjust the current navigation session to follow the alternate route. For example, the user computing device 102 may verbally provide the alternate route output through the speaker 206, and/or may visually indicate the alternate route output through the prompt 324. As illustrated in FIG. 3B, the alternate route output may state “There is an Alternate Route that decreases travel time by 10 minutes. Would you like to switch to the Alternate Route?” This phrasing may be verbally provided to the user 202 through the speaker 206, as well as the visual presentation through the display screen 322.

If the user 202 decides to provide a verbal user input (transmission to the user computing device 102 indicated by 322b), then the user 202 may verbally respond to the alternate route output within a brief period (e.g., 5-10 seconds) after the output is provided to the user 202 in order for the user computing device 102 to receive the verbal user input. The user computing device 102 may receive the verbal user input, and may proceed to process/analyze the verbal user input similarly to the analysis described herein in reference to FIGS. 2A-2C. In particular, if the user 202 decides to accept the alternate route, then the user computing device 102 may initiate an updated navigation session to provide alternate turn-by-turn navigation instructions based on the alternate route. Alternatively, if the user 202 decides to decline the alternate route, then the user computing device 102 may continue providing the turn-by-turn navigation instructions corresponding to the accepted route, and may not initiate an updated navigation session.

Further, the visual rendering of the alternate route output may include interactive buttons 324a, 324b that enable the user 202 to physically interact with the display screen 322 in order to accept or decline switching to the alternate route. When the user receives the prompt 324, the user may interact with the prompt 324 by pressing, clicking, tapping, swiping, etc. one of the interactive buttons 324a, 324b. If the user selects the “Yes” interactive button 324a, then the user computing device 102 may instruct the navigation application 108 to generate and render turn-by-turn navigation directions as part of an updated navigation session corresponding to the alternate route. If the user selects the “No” interactive button 324b, then the user computing device 102 may continue generating and rendering turn-by-turn navigation instructions corresponding to the accepted route, and may not generate/render an updated navigation session.

### Example Logic for Determining Places and Routes Through Natural Conversation

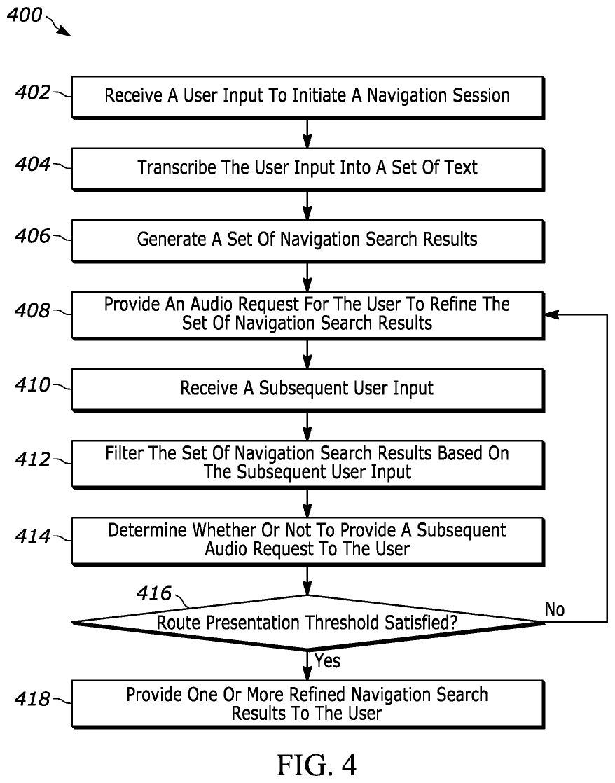

FIG. 4 is a flow diagram of an example method 400 for determining places and routes through natural conversation, which can be implemented in a computing device, such as the user computing device 102 of FIG. 1. It is to be understood that, for case of discussion only, the “user computing device” discussed herein in reference to FIG. 4 may correspond to the user computing device 102. Further, it is to be understood that, throughout the description of FIG. 4, actions described as being performed by the user computing device 102 may, in some implementations, be performed by the external server 120, the vehicle computing device 150, and/or may be performed by the user computing device 102, the navigation server 120, and/or the vehicle computing device 150 in parallel. For example, the user computing device 102, the navigation server 120, and/or the vehicle computing device 150 may utilize the language processing module 109a, 120a, 153a and/or the machine learning module 109b, 120c, 153c to determine routes and places through natural conversation with the user.

Turning to FIG. 4, a method 400 can be implemented by a user computing device (e.g., the user computing device 102). The method 400 can be implemented in a set of instructions stored on a computer-readable memory and executable at one or more processors of the user computing device (e.g., the processor(s) 104).

At block 402 the method 400 includes receiving, from a user, a speech input including a search query to initiate a navigation session (block 402). The method 400 may further include the optional step of transcribing the speech input into a set of text (block 404). In certain aspects, the method 400 may further include parsing, by one or more processors, the set of text to determine a destination value, and extracting the destination value from the set of text. Further in these aspects, the method 400 may include searching for the destination value in a destination database (e.g., map database 156, external server 120), and identifying the plurality of destinations based on results of searching the destination database. Accordingly, in these aspects, the method 400 may further include generating one or more routes to each destination of the plurality of destinations.

The method 400 also includes generating a set of navigation search results responsive to the search query (block 406). The set of navigation search results may include a plurality of destinations or a plurality of routes corresponding to the plurality of destinations. In some aspects, generating the set of navigation search results responsive to the search query further includes transcribing the speech input into a set of text, and applying a machine learning (ML) model to the set of text in order to output a user intent and a destination. In these aspects, the ML model may be trained using one or more training data sets of text in order to output one or more training intents and one or more training destinations.

In certain aspects, generating the set of navigation search results responsive to the search query further includes generating one or more candidate routes to each destination of the plurality of destinations based on a respective set of attributes for each candidate route of the one or more candidate routes. In these aspects, each respective set of attributes may include one or more of (i) a mode of transportation, (ii) a number of changes, (iii) a total travel distance, (iv) a total travel time, (v) a total travel distance on each included roadway, or (vi) a total travel time on each included roadway.

The method 400 further includes providing an audio request for refining the set of navigation search results to the user (block 408). In some aspects, the method 400 may further include determining whether or not to provide the audio request to the user based on at least one of (i) a total number of routes included in the plurality of routes, (ii) a device type of a device used by the user to provide the speech input, (iii) an input type provided by the user, or (iv) a second number of routes included in the plurality of routes that satisfy a quality threshold.

In certain aspects, the method 400 may include verbally communicating, by a text-to-speech (TTS) engine (e.g., TTS engine 109a2), the audio request for consideration by the user. Further, in some aspects, providing the audio request for refining the set of navigation search results to the user further includes determining a primary attribute of the plurality of routes that would result in a largest reduction of the plurality of routes, and generating the audio request for the user based on the primary attribute. In certain aspects, providing the audio request for refining the set of navigation search results to the user further may include generating, by executing a large language model (LLM), the audio request based on an attribute of the plurality of routes.

The method 400 further includes, in response to the audio request, receiving, from the user, a subsequent speech input including a refined search query (block 410). In certain aspects, the method 400 may further include recognizing the speech input and the subsequent speech input based on a trigger phrase included as part of both the speech input and the subsequent speech input.

The method 400 may further include the optional step of filtering the set of navigation search results based on the subsequent user input (block 412). Namely, in certain aspects, the method 400 may further include transcribing the speech input into a set of text, (a) providing the audio request for refining the set of navigation search results to the user, (b) in response to the audio request, receiving, from the user, the subsequent speech input including the refined search query, and (c) filtering the set of navigation search results to generate the one or more refined navigation search results by eliminating routes of the plurality of routes based on the subsequent speech input. In certain aspects, filtering the set of navigation search results to generate the one or more refined navigation search results further comprises eliminating, by executing a machine learning (ML) model, the routes in the set of routes with a respective relevance score that does not satisfy a relevance threshold based on a natural language transcription of the subsequent speech input.

Further in these aspects, the natural language transcription may not be parsed, and the ML model may be configured to receive natural language transcriptions and routes as input in order to output relevance scores for each route. Instead, the ML model may be trained with transcription strings of speech inputs and training routes in order to output a relevance score corresponding to each respective training route. The relevance score may generally indicate how relevant a particular route is based on the transcription string of the user input. In this manner, the ML model may operate on a more “end-to-end” basis by not parsing the user input to extract explicit attributes, but determining a relevance score for each route based on the user's input. For example, the ML model may receive a natural language transcription of a subsequent user input stating “I'd prefer no single track roads,” and two routes from the set of routes as inputs. The first route may include navigation instructions directing a user to travel along a series of single track roads, and the second route may include navigation instructions directing a user to travel along no single track roads.

Continuing the above example, the ML model may output relevance scores for the two routes that may either indicate relevance as an indicator of route viability or of route non-viability. Namely, the ML model may output a relevance score for the first route that is relatively high (e.g., 9 out of 10) because the first route includes as series of single track roads, and the ML model may output a relevance score for the second route that is relatively low (e.g., 1 out of 10) because the second route includes no single track roads. In this manner, the relevance score may indicate route non-viability because the first route has a high relevance score based on the first route including a series of single track roads (which the user does not want), while the second route has a low relevance score based on the second route including no single track roads (which the user prefers). Alternatively, the ML model may output a relevance score for the first route that is relatively low (e.g., 1 out of 10) because the first route includes as series of single track roads, and the ML model may output a relevance score for the second route that is relatively high (e.g., 9 out of 10) because the second route includes no single track roads. In this manner, the relevance score may indicate route viability because the first route has a low relevance score based on the first route including a series of single track roads (which the user does not want), while the second route has a high relevance score based on the second route including no single track roads (which the user prefers).

The method 400 may also include the optional step of determining whether or not to provide a subsequent audio request to the user based on the one or more refined navigation search results (block 414). In particular, optionally, the user computing device 102 may determine whether or not the set of navigation search results satisfies a route presentation threshold (block 416). If the user computing device 102 determines that the set of navigation search results does not satisfy the route presentation threshold (NO branch of block 416), then the method 400 may return to block 408 where the user computing device 102 provides a subsequent audio request to the user. However, if the user computing device 102 determines that the set of navigation search results does satisfy the route presentation threshold (YES branch of block 416), then the method 400 may continue to block 418. It should be understood that the method 400 may include iteratively performing each of blocks 408-416 (and/or any other blocks of method 400) any suitable number of times until the one or more refined navigation search results satisfies the route presentation threshold.

In any event, the method 400 further includes providing one or more refined navigation search results responsive to the refined search query including a subset of the plurality of destinations or the plurality of routes (block 418). In some aspects, the method 400 may further include providing, at a user interface, the one or more refined navigation search results for viewing by the user.

In certain aspects, the method 400 may include receiving, from the user, a verbal route acceptance input indicating an accepted route from the one or more refined navigation search results. In these aspects, the method 400 may further include displaying, at the user interface, the accepted route for viewing by the user, and initiating the navigation session along the accepted route by providing verbal navigation instructions corresponding to the accepted route as the user travels along the accepted route.

In some aspects, providing the one or more refined navigation search results responsive to the refined search query further includes generating, by executing a large language model (LLM), a textual summary for each route of the subset of the plurality of routes. Further in these aspects, the method 400 may include providing, at the user interface, the subset of the plurality of routes and each respective textual summary for viewing by the user.

In certain aspects, the method 400 may further include receiving, from the user, a selection of an accepted route to initiate the navigation session traveling along the accepted route. Additionally, in these aspects, the method 400 may include determining, during the navigation session, that an alternate route improves at least one of (i) a user arrival time, (ii) a user distance traveled, or (iii) a user time on specific roadways. The method 400 may also include prompting, during the navigation session, the user with an option to switch from a selected route to the alternate route through either a verbal prompt or a textual prompt.

### Aspects of the Present Disclosure

1. A method in a computing device for determining places and routes through natural conversation, the method comprising: receiving, from a user, a speech input including a search query to initiate a navigation session; generating, by one or more processors, a set of navigation search results responsive to the search query, the set of navigation search results including a plurality of destinations and/or a plurality of routes corresponding to one or more destinations; providing, by the one or more processors, an audio request for refining the set of navigation search results to the user; in response to the audio request, receiving, from the user, a subsequent speech input including a refined search query; and providing, by the one or more processors, one or more refined navigation search results responsive to the refined search query including a subset of the plurality of destinations and/or the plurality of routes.

2. The method of aspect 1, further comprising: transcribing, by an automatic speech recognition (ASR) engine, the speech input into a set of text; (a) providing, by the one or more processors, the audio request for refining the set of navigation search results to the user; (b) in response to the audio request, receiving, from the user, the subsequent speech input including the refined search query; (c) filtering, by the one or more processors, the set of navigation search results to generate the one or more refined navigation search results by eliminating routes of the plurality of routes based on the subsequent speech input; (d) determining, by the one or more processors, whether or not to provide a subsequent audio request to the user based on the one or more refined navigation search results; and (c) iteratively performing (a)-(c) until the one or more refined navigation search results satisfies a threshold.

3. The method of aspect 2, wherein filtering the set of navigation search results to generate the one or more refined navigation search results further comprises: eliminating, by the one or more processors executing a machine learning (ML) model, the routes in the set of routes with a respective relevance score that does not satisfy a relevance threshold based on a natural language transcription of the subsequent speech input, wherein the natural language transcription is not parsed, and the ML model is configured to receive natural language transcriptions and routes as input in order to output relevance scores for each route.

4. The method of any of aspects 1-3, further comprising: providing, at a user interface, the one or more refined navigation search results for viewing by the user.

5. The method of any of aspects 1-4, further comprising: determining, by the one or more processors, whether or not to provide the audio request to the user based on at least one of (i) a total number of routes included in the plurality of routes, (ii) a device type of a device used by the user to provide the speech input, (iii) an input type provided by the user, or (iv) a second number of routes included in the plurality of routes that satisfy a quality threshold.

6. The method of any of aspects 1-5, further comprising: verbally communicating, by a text-to-speech (TTS) engine, the audio request for consideration by the user.

7. The method of any of aspects 1-6, further comprising: receiving, from the user, a verbal route acceptance input indicating an accepted route from the one or more refined navigation search results; displaying, at the user interface, the accepted route for viewing by the user; and initiating, by the one or more processors, the navigation session along the accepted route by providing verbal navigation instructions corresponding to the accepted route as the user travels along the accepted route.

8. The method of any of aspects 1-7, wherein generating the set of navigation search results responsive to the search query further comprises: transcribing the speech input into a set of text; and applying, by the one or more processors, a machine learning (ML) model to the set of text in order to output a user intent and a destination, wherein the ML model is trained using one or more training data sets of text in order to output one or more training intents and one or more training destinations.

9. The method of any of aspects 1-8, further comprising: transcribing the speech input into a set of text; parsing, by the one or more processors, the set of text to determine a destination value; extracting, by the one or more processors, the destination value from the set of text; and searching, by the one or more processors, for the destination value in a destination database.

10. The method of aspect 9, further comprising: identifying, by the one or more processors, the plurality of destinations based on results of searching the destination database; and generating, by the one or more processors, one or more routes to each destination of the plurality of destinations.

11. The method of any of aspects 1-10, wherein generating the set of navigation search results responsive to the search query further comprises: generating, by the one or more processors, one or more candidate routes to each destination of the plurality of destinations based on a respective set of attributes for each candidate route of the one or more candidate routes, wherein each respective set of attributes includes one or more of (i) a mode of transportation, (ii) a number of changes, (iii) a total travel distance, (iv) a total travel time, (v) a total travel distance on each included roadway, or (vi) a total travel time on each included roadway.

12. The method of any of aspects 1-11, wherein providing the audio request for refining the set of navigation search results to the user further comprises: determining, by the one or more processors, a primary attribute of the plurality of routes that would result in a largest reduction of the plurality of routes; and generating, by the one or more processors, the audio request for the user based on the primary attribute.

13. The method of any of aspects 1-12, wherein providing the audio request for refining the set of navigation search results to the user further comprises: generating, by the one or more processors executing a large language model (LLM), the audio request based on an attribute of the plurality of routes.

14. The method of any of aspects 1-13, wherein providing one or more refined navigation search results responsive to the refined search query further comprises: generating, by the one or more processors executing a large language model (LLM), a textual summary for each route of the subset of the plurality of routes; and providing, at the user interface, the subset of the plurality of routes and each respective textual summary for viewing by the user.

15. The method of any of aspects 1-14, further comprising: receiving, from the user, a selection of an accepted route to initiate the navigation session traveling along the accepted route; determining, during the navigation session, that an alternate route improves at least one of (i) a user arrival time, (ii) a user distance traveled, or (iii) a user time on specific roadways; and prompting, during the navigation session, the user with an option to switch from a selected route to the alternate route through either a verbal prompt or a textual prompt.

16. The method of any of aspects 1-15, further comprising: recognizing, by the one or more processors, the speech input and the subsequent speech input based on a trigger phrase included as part of both the speech input and the subsequent speech input.

17. A computing device for determining places and routes through natural conversation, the computing device comprising: a user interface; one or more processors; and a computer-readable memory, which is optionally non-transitory, coupled to the one or more processors and storing instructions thereon that, when executed by the one or more processors, cause the computing device to: receive, from a user, a speech input including a search query to initiate a navigation session, generate a set of navigation search results responsive to the search query, the set of navigation search results including a plurality of destinations or a plurality of routes corresponding to one or more destinations, provide an audio request for refining the set of navigation search results to the user, in response to the audio request, receive, from the user, a subsequent speech input including a refined search query, and provide one or more refined navigation search results responsive to the refined search query including a subset of the plurality of destinations or the plurality of routes.

18. The computing device of aspect 17, wherein the instructions, when executed by the one or more processors, cause the computing device to: transcribe, by an automatic speech recognition (ASR) engine, the speech input into a set of text; (a) provide the audio request for refining the set of navigation search results to the user; (b) in response to the audio request, receive, from the user, the subsequent speech input including the refined search query; (c) filter the set of navigation search results to generate the one or more refined navigation search results by eliminating routes of the plurality of routes based on the subsequent speech input; (d) determine whether or not to provide a subsequent audio request to the user based on the one or more refined navigation search results; and (e) iteratively perform (a)-(c) until the one or more refined navigation search results satisfies a threshold.

19. A computer-readable medium, which is optionally non-transitory storing instructions for determining places and routes through natural conversation, that when executed by one or more processors cause the one or more processors to: receive, from a user, a speech input including a search query to initiate a navigation session; generate a set of navigation search results responsive to the search query, the set of navigation search results including a plurality of destinations or a plurality of routes corresponding to one or more destinations; provide an audio request for refining the set of navigation search results to the user; in response to the audio request, receive, from the user, a subsequent speech input including a refined search query; and provide one or more refined navigation search results responsive to the refined search query including a subset of the plurality of destinations or the plurality of routes.

20. The computer-readable medium of aspect 19, wherein the instructions, when executed by the one or more processors, further cause the one or more processors to: transcribe, by an automatic speech recognition (ASR) engine, the speech input into a set of text; (a) provide the audio request for refining the set of navigation search results to the user; (b) in response to the audio request, receive, from the user, the subsequent speech input including the refined search query; (c) filter the set of navigation search results to generate the one or more refined navigation search results by eliminating routes of the plurality of routes based on the subsequent speech input; (d) determine whether or not to provide a subsequent audio request to the user based on the one or more refined navigation search results; and (e) iteratively perform (a)-(e) until the one or more refined navigation search results satisfies a threshold.

21. A computing device for determining places and routes through natural conversation, the computing device comprising: a user interface; one or more processors; and a non-transitory computer-readable memory coupled to the one or more processors and storing instructions thereon that, when executed by the one or more processors, cause the computing device to carry out any of the methods disclosed herein.

22. A tangible, non-transitory computer-readable medium storing instructions for determining places and routes through natural conversation, that when executed by one or more processors cause the one or more processors to carry out any of the methods disclosed herein.

23. A method in a computing device for determining places and routes through natural conversation, the method comprising: receiving input from a user to initiate a navigation session; generating, by one or more processors, one or more destinations or one or more routes responsive to the user input; providing, by the one or more processors, a request to the user for refining a response to the user input; in response to the request, receiving subsequent input from the user; and providing, by the one or more processors, one or more updated destinations or one or more updated routes in response to the subsequent user input.

24. The method of aspect 23, wherein the user input is speech input or text input, and the request is an audio request or a text request.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 400 may include one or more function blocks, modules, individual functions or routines in the form of tangible computer-executable instructions that are stored in a computer-readable storage medium, optionally a non-transitory computer-readable storage medium, and executed using a processor of a computing device (e.g., a server device, a personal computer, a smart phone, a tablet computer, a smart watch, a mobile computing device, or other client computing device, as described herein). The method 400 may be included as part of any backend server (e.g., a map data server, a navigation server, or any other type of server computing device, as described herein), client computing device modules of the example environment, for example, or as part of a module that is external to such an environment. Though the figures may be described with reference to the other figures for case of explanation, the method 400 can be utilized with other objects and user interfaces. Furthermore, although the explanation above describes steps of the method 400 being performed by specific devices (such as a user computing device), this is done for illustration purposes only. The blocks of the method 400 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for determining places and routes through natural conversation through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method in a computing device for determining places and routes through natural conversation, the method comprising:
receiving, from a user, a speech input including a search query to initiate a navigation session;
generating, by one or more processors, a set of navigation search results responsive to the search query, the set of navigation search results including a plurality of destinations or a plurality of routes corresponding to one or more destinations;
providing, by the one or more processors, an audio request to the user for refining the set of navigation search results;
in response to the audio request, receiving, from the user, a subsequent speech input including a refined search query; and
providing, by the one or more processors, one or more refined navigation search results responsive to the refined search query including a subset of the plurality of destinations or the plurality of routes.

2. The method of claim 1, further comprising:
transcribing, by an automatic speech recognition (ASR) engine, the speech input into a set of text;
(a) providing, by the one or more processors, the audio request to the user for refining the set of navigation search results;
(b) in response to the audio request, receiving, from the user, the subsequent speech input including the refined search query;
(c) filtering, by the one or more processors, the set of navigation search results to generate the one or more refined navigation search results by eliminating routes of the plurality of routes based on the subsequent speech input;
(d) determining, by the one or more processors, whether or not to provide a subsequent audio request to the user based on the one or more refined navigation search results; and
(e) iteratively performing (a)-(d) until the one or more refined navigation search results satisfies a threshold.

3. The method of claim 2, wherein filtering the set of navigation search results to generate the one or more refined navigation search results further comprises:
eliminating, by the one or more processors executing a machine learning (ML) model, the routes in the set of routes with a respective relevance score that does not satisfy a relevance threshold based on a natural language transcription of the subsequent speech input, wherein the natural language transcription is not parsed, and the ML model is configured to receive natural language transcriptions and routes as input in order to output relevance scores for each route.

4. The method of claim 1, further comprising:
providing, at a user interface, the one or more refined navigation search results for viewing by the user.

5. The method of claim 1, further comprising:
determining, by the one or more processors, whether or not to provide the audio request to the user based on at least one of (i) a total number of routes included in the plurality of routes, (ii) a device type of a device used by the user to provide the speech input, (iii) an input type provided by the user, or (iv) a second number of routes included in the plurality of routes that satisfy a quality threshold.

6. The method of claim 1, further comprising:
verbally communicating, by a text-to-speech (TTS) engine, the audio request for consideration by the user.

7. The method of claim 1, further comprising:
receiving, from the user, a verbal route acceptance input indicating an accepted route from the one or more refined navigation search results;
displaying, at the user interface, the accepted route for viewing by the user; and
initiating, by the one or more processors, the navigation session along the accepted route by providing verbal navigation instructions corresponding to the accepted route as the user travels along the accepted route.

8. The method of claim 1, wherein generating the set of navigation search results responsive to the search query further comprises:
transcribing the speech input into a set of text; and
applying, by the one or more processors, a machine learning (ML) model to the set of text in order to output a user intent and a destination, wherein the ML model is trained using one or more training data sets of text in order to output one or more training intents and one or more training destinations.

9. The method of claim 1, further comprising:
transcribing the speech input into a set of text;
parsing, by the one or more processors, the set of text to determine a destination value;
extracting, by the one or more processors, the destination value from the set of text; and
searching, by the one or more processors, for the destination value in a destination database.

10. The method of claim 9, further comprising:
identifying, by the one or more processors, the plurality of destinations based on results of searching the destination database; and
generating, by the one or more processors, one or more routes to each destination of the plurality of destinations.

11. The method of claim 1, wherein generating the set of navigation search results responsive to the search query further comprises:
generating, by the one or more processors, one or more candidate routes to each destination of the plurality of destinations based on a respective set of attributes for each candidate route of the one or more candidate routes, wherein each respective set of attributes includes one or more of (i) a mode of transportation, (ii) a number of changes, (iii) a total travel distance, (iv) a total travel time, (v) a total travel distance on each included roadway, or (vi) a total travel time on each included roadway.

12. The method of claim 1, wherein providing the audio request to the user for refining the set of navigation search results further comprises:
determining, by the one or more processors, a primary attribute of the plurality of routes that would result in a largest reduction of the plurality of routes; and
generating, by the one or more processors, the audio request for the user based on the primary attribute.

13. The method of claim 1, wherein providing the audio request to the user for refining the set of navigation search results further comprises:
generating, by the one or more processors executing a large language model (LLM), the audio request based on an attribute of the plurality of routes.

14. The method of claim 1, wherein providing one or more refined navigation search results responsive to the refined search query further comprises:
generating, by the one or more processors executing a large language model (LLM), a textual summary for each route of the subset of the plurality of routes; and
providing, at the user interface, the subset of the plurality of routes and each respective textual summary for viewing by the user.

15. The method of claim 1, further comprising:
receiving, from the user, a selection of an accepted route to initiate the navigation session traveling along the accepted route;
determining, during the navigation session, that an alternate route improves at least one of (i) a user arrival time, (ii) a user distance traveled, or (iii) a user time on specific roadways; and
prompting, during the navigation session, the user with an option to switch from a selected route to the alternate route through either a verbal prompt or a textual prompt.

16. The method of claim 1, further comprising:
recognizing, by the one or more processors, the speech input and the subsequent speech input based on a trigger phrase included as part of both the speech input and the subsequent speech input.

17. A computing device for determining places and routes through natural conversation, the computing device comprising:
a user interface;
one or more processors; and
a computer-readable memory coupled to the one or more processors and storing instructions thereon that, when executed by the one or more processors, cause the computing device to:
receive, from a user, a speech input including a search query to initiate a navigation session,
generate a set of navigation search results responsive to the search query, the set of navigation search results including a plurality of destinations or a plurality of routes corresponding to one or more destinations,
provide an audio request to the user for refining the set of navigation search results,
in response to the audio request, receive, from the user, a subsequent speech input including a refined search query, and
provide one or more refined navigation search results responsive to the refined search query including a subset of the plurality of destinations or the plurality of routes.

18. The computing device of claim 17, wherein the instructions, when executed by the one or more processors, cause the computing device to:
transcribe, by an automatic speech recognition (ASR) engine, the speech input into a set of text;
(a) provide the audio request to the user for refining the set of navigation search results;
(b) in response to the audio request, receive, from the user, the subsequent speech input including the refined search query;
(c) filter the set of navigation search results to generate the one or more refined navigation search results by eliminating routes of the plurality of routes based on the subsequent speech input;
(d) determine whether or not to provide a subsequent audio request to the user based on the one or more refined navigation search results; and
(e) iteratively perform (a)-(d) until the one or more refined navigation search results satisfies a threshold.

19. A computer-readable medium storing instructions for determining places and routes through natural conversation, that when executed by one or more processors cause the one or more processors to:
receive, from a user, a speech input including a search query to initiate a navigation session;
generate a set of navigation search results responsive to the search query, the set of navigation search results including a plurality of destinations or a plurality of routes corresponding to one or more destinations;
provide an audio request to the user for refining the set of navigation search results;
in response to the audio request, receive, from the user, a subsequent speech input including a refined search query; and
provide one or more refined navigation search results responsive to the refined search query including a subset of the plurality of destinations or the plurality of routes.

20. The computer-readable medium of claim 19, wherein the instructions, when executed by the one or more processors, further cause the one or more processors to:
transcribe, by an automatic speech recognition (ASR) engine, the speech input into a set of text;
(a) provide the audio request to the user for refining the set of navigation search results;
(b) in response to the audio request, receive, from the user, the subsequent speech input including the refined search query;
(c) filter the set of navigation search results to generate the one or more refined navigation search results by eliminating routes of the plurality of routes based on the subsequent speech input;
(d) determine whether or not to provide a subsequent audio request to the user based on the one or more refined navigation search results; and
(e) iteratively perform (a)-(d) until the one or more refined navigation search results satisfies a threshold.

21. A method in a computing device for determining places and routes, the method comprising:
receiving input from a user to initiate a navigation session;
generating, by one or more processors, one or more destinations or one or more routes responsive to the user input;
providing, by the one or more processors, a request to the user for refining a response to the user input;
in response to the request, receiving subsequent input from the user; and
providing, by the one or more processors, one or more updated destinations or one or more updated routes in response to the subsequent user input.

22. The method of claim 21, wherein the user input is speech input or text input, and the request is an audio request or a text request.
